(19) United States
(12) Patent Application Publication
(10) Pub. No.: US 2008/0042513 A1
(43) Pub. Date: Feb. 21, 2008

(54) Sliding Body Holder

(76) Inventors: Gerald Kuenzel, Lichtenau (DE); Christof Bernauer, Hundsbach (DE); Christian Bauer, Lauf (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/660,453

(22) PCT Filed: Jun. 30, 2005
(86) PCT No.: PCT/EP05/53101

§ 371 Date: Feb. 16, 2007

(30) Foreign Application Priority Data
Aug. 27, 2004 (DE) 10 2004 041 490.4

(51) Int. Cl. H01R 39/38; H02K 5/14

(52) U.S. Cl. 310/247; 310/233; 310/51

(57) ABSTRACT

A commutator machine and a sliding body holder for electrically contacting a rotor has at least one sliding body and a leaf spring which centrally supports the sliding body and is fixed on its end to a carrier which is stationary relative to the rotor and which generates a radially oriented contact-pressure force at the sliding body for pressing the sliding body against the rotor. To attain good noise decoupling of the sliding body with regard to the carrier, the geometry of the leaf spring is designed such that the sliding body and the carrier are largely vibrationally decoupled from one another.

### PRIOR ART

The invention is based on a sliding body holder for electrically contacting a rotor, in particular a brush holder for a commutator machine or slipring machine, as generically defined by the preamble to claim 1.

A known device for contacting laminations of a commutator or collector of an electric motor (German Patent Disclosure DE 197 50 038 A1) has one curved leaf spring, made from a strip of material such as spring sheet metal, disposed on each of the diametrically opposed sides of the collector, and this leaf spring carries a carbon brush in the middle and is fastened on its end to the carrier. The carrier is formed by an end shield, in which the motor shaft which supports the collector and the rotor of the electric motor in a manner fixed against relative rotation is supported. Four retaining bolts protrude axially from the bearing bolt, and the ends of the two leaf springs are firmly fastened in them. One retaining bolt of each pair of bolts has an electrical contact, which is connected to the carbon brush via an electrical connection pigtail. On its face end remote from the collector, the carbon brush has a protruding peg that penetrates a centrally located cutout in the leaf spring. In the region of the cutout, the leaf spring has two diametrically opposed bending tabs, which serve to fasten it to the carbon brush. To prevent tilting of the carbon brushes in operation of the electric motor, the peg and the cutout are embodied polygonally.

### ADVANTAGES OF THE INVENTION

The sliding body holder of the invention, in particular the brush holder of the invention, having the characteristics of claim 1 has the advantage that not only are precise positioning of the sliding body on the rotor and uniform operation of the sliding body in both directions of rotation of the rotor assured by the fastening of the leaf spring on both sides; in addition, because of the vibrational decoupling done, the vibration of the sliding body, to which the sliding body is induced by nonconcentricities of the rotor and in particular the lamination pitch of a commutator, is not transmitted to the carrier and thus to the machine housing receiving the carrier and hence is emitted as annoying running noise. The vibrational decoupling of the sliding body is achieved in a simple way by means of an adapted design of the form or geometry of the leaf spring both in the radial direction and in the tangential or circumferential direction, in each case relative to the rotor.

By the provisions recited in the further claims, advantageous refinements of and improvements to the sliding body holder disclosed in claim 1 are possible.

In a preferred embodiment of the invention, the leaf spring has a curved back, supporting the sliding body, and spring legs, which continue on both ends of the back of the leaf spring and are embodied resiliently in the direction of the back of the leaf spring and in the direction of the normal to the back of the leaf spring or in other words radially to the rotor once the sliding body holder has been installed.

Advantageously, in a further embodiment of the invention, the back of the leaf spring and the two spring legs are produced in one piece from a common strip of material; and that the spring legs are formed from bent portions of the strip of material that are at least partially cut out in the center in order to adjust the resilience. This design of the spring geometry allows relatively fine tuning of spring stiffness of the leaf spring to the vibration frequency occurring at the sliding body.

In an advantageous embodiment of the invention, a bent or angled first portion, adjoining the back of the leaf spring, of a spring leg extends approximately perpendicular to the back of the leaf spring on the back side of the back of the leaf spring, remote from the sliding body; a second portion of the spring leg, bent by approximately 90° away from the first portion, extends approximately parallel to the back of the leaf spring; a third portion, bent approximately 90° away from the second portion toward the back of the leaf spring, extends parallel to the first portion; and a fourth portion, bent from the third portion by approximately 90° away from the first portion, extends approximately perpendicular to the first portion, and the fourth portion is fastened at its end in the carrier. As a result of this embodiment of the spring legs, a plurality of leaf springs with sliding bodies can be accommodated in a small space in the carrier.

In an advantageous embodiment of the invention, one contact lug for supplying or drawing current is fastened to the two fourth portions of each of the spring legs, the securing being done by riveting, soldering, or welding. This is the case whenever the sheet metal of the leaf spring itself is not thick enough to enable using the fourth portions of the spring legs directly as contacts. Alternatively, the contact lugs may be produced integrally with the spring legs, by bringing the ends of the legs to a thickness required for contact by repeatedly folding them and placing them against one another.

In an advantageous embodiment of the invention, the back of the leaf spring of the leaf spring, on its long sides extending in the circumferential direction, has angled portions protruding toward the sliding body. The width of the back of the leaf spring is dimensioned such that the sliding body is received by positive engagement between the angled portions. These angled portions, or crimped-over portions, of the back of the leaf spring serve on the one hand to adjust the radial stiffness of the leaf spring and on the other to provide defined conduction onward of the circumferential forces, occurring at the sliding body, to the spring legs. As a result, a positioning or canting motion that the sliding body executes upon rotation of the rotor in the circumferential direction is minimized, and hence the sliding contact with the rotor is improved. In addition, the angled portions assure that the sliding body is secured against relative rotation about its vertical axis pointing in the radial direction of the rotor.

### DRAWINGS

The invention is described in further detail in the ensuing description in terms of an exemplary embodiment shown in the drawings. Shown are:

FIG. 1, a plan view on a brush holder for a commutator machine embodied as an internal rotor machine;

FIG. 2, a perspective view of a leaf spring with a sliding body of the brush holder in FIG. 1;

FIG. 3, a fragmentary enlarged view of the brush holder in FIG. 1, with the commutator omitted;

FIG. 4, the same view as in FIG. 3, with the commutator inserted.

### DESCRIPTION OF THE EXEMPLARY EMBODIMENT

In FIG. 1, a brush holder for a commutator machine, embodied as an internal rotor machine, motor or generator, is shown in plan view as an exemplary embodiment for a sliding body holder for electrically contacting a rotor. The brush holder has an annular carrier 11, which is preferably made from plastic and which in the installed state concentrically surrounds a commutator that is seated in a manner fixed against relative rotation on the rotor shaft of the commutator machine. The commutator of the commutator machine is suggested in dashed lines in FIG. 1 and is shown in fragmentary form in plan view in FIG. 4. In the conventional way, commutator laminations 101 are embodied on the circumference of the commutator 10 and are separated electrically from one another by narrow slots 102.

The brush holder has a total of four sliding bodies 12, also known as commutator or carbon brushes, which are offset by equal circumferential angles from one another on the commutator 10 and pressed with spring force against the commutator 10 by their inward-pointing face ends. Each sliding body 12 is fastened centrally to a leaf spring 13, which is fixed on its end in the carrier 11 and generates the radially oriented contact-pressure force for pressing the sliding body 12 against the commutator 10. The geometry of the leaf spring 13 is designed such that a vibrational decoupling of the sliding body 12 from the carrier 11 exists, and as a result, the vibration induced by production-dictated inaccuracies of shape of the commutator 10 and particularly by the slotting of the commutator 10 are not transmitted to the carrier 10 and hence to the housing of the commutator machine and emitted past the housing in the form of annoying high-frequency running noise.

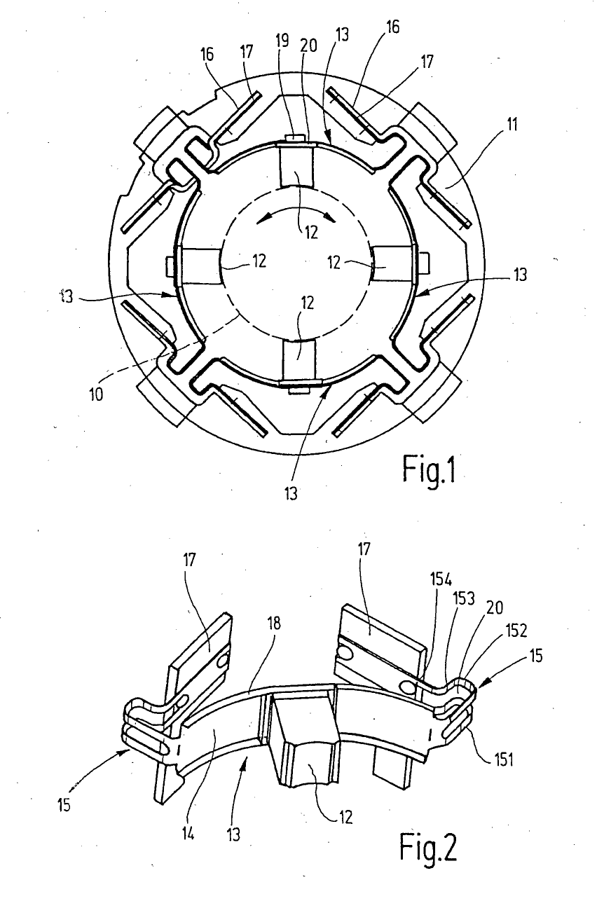

The geometric design of the leaf spring 13 provided for this purpose can be seen particularly from FIG. 2. The leaf spring 13 has a curved back 14, carrying the sliding body 12 in the middle, and two identically embodied spring legs 15, extending to the left and right on the ends of the back 14 of the leaf spring, which are embodied resiliently in the longitudinal direction of the back 14 of the leaf spring, or in other words the circumferential direction of the commutator 10 on the one hand and in the direction of the normal to the back 14 of the leaf spring, that is, radially to the commutator 10, on the other. The back 14 of the leaf spring and the two spring legs 15 are produced in one piece from a common strip of material, preferably a copper-alloy spring sheet. The spring legs 15 are formed by bending or angling portions 151 through 154 of the strip of material. The portions 151-154 are at least partially cut out in the center, for the sake of finely adjusting the resilience of the spring legs 15. The bending or angling is done in such a way that in each spring leg 15, a first portion 151, bent or angled by approximately 90° and adjoining the back 14 of the leaf spring, projects from the back side of the back 14 of the leaf spring facing away from the sliding body 12; a second portion 152, bent by approximately 90° from the first portion, extends approximately parallel to the back 14 of the leaf spring; a third portion 153, bent approximately 90° toward the back 14 of the leaf spring from the second portion 152, extends approximately parallel to the first portion 151; and a fourth portion 154, bent from the third portion 153 by approximately 90° away from the first portion, extends approximately perpendicular to the first portion 151. The angles stated for the bends of the portions 151-154 pertain only to the exemplary embodiment described here. It is understood to be possible to select other values for the angles of the bends. The cutout 16 provided in the spring legs 15 for fine-tuning of the spring stiffness extends through the first portion 151, the second portion 152, and the third portion 153 of the spring leg 15 and extends partway into the fourth portion 154 of the spring leg 15. The adjoining end, without a cutout, of the fourth portion 154 of the spring legs 15 is fixed on the carrier 11. To that end, the annular carrier 11 has four pairs, offset from one another on the circumference by the same spacing, of axial slots 16, and the axial slots 16 of each pair are located symmetrically to a radial axis of symmetry, and the axes of symmetry of the pairs are offset from one another by the same circumferential angles. In each axial slot 16 of one pair, one leaf spring 13 is clamped by positive engagement to the end of the fourth portion 154 of the two spring legs 15.

The electrical contacting of the sliding bodies 12 takes place via the leaf springs 13; the connection pigtails, not shown here, are connected to contact lugs 17. One contact lug 17 is fastened to the end of the fourth portion 154 of each of the spring legs 15, for instance being riveted, as shown in FIG. 2, or soldered or welded. The contact lugs 17 are clamped in the axial slots 16 in the carrier 11, together with the ends of the fourth portions 154 of the spring legs 15. The contact lugs 17 may be omitted, if the leaf spring 13 has a sufficient leaf thickness and can as a result be used as a direct contact for the connection pigtails or as a direct plug contact for the plug connection. Also, a contact lug or plug contact with the requisite thickness can be formed by repeated folded of the ends of the spring legs 15 and placing them on one another.

The back 14 of the leaf spring, on its long sides extending in the circumferential direction of the commutator 10, is provided with angled portions 18, which protrude from the back 14 of the leaf spring on the front side of the back 14 of the leaf spring that carries the sliding body 12, at a right angle to the back 14 of the leaf spring. The width of the back 14 of the leaf spring in the axial direction is dimensioned such that the sliding body 12 is received by positive engagement between the diametrically opposed angled portions 18, and as a result, rotation of the sliding body 12 relative to the back 14 of the leaf spring is prevented. The sliding body 12 is fastened to the back of the leaf spring, and this fastening can be done in various ways, such as by adhesive bonding, soldering, and the like. In the exemplary embodiment, the sliding body 12, on its face end remote from the commutator 10, has a peg 19 which protrudes through a cutout 20 in the back 14 of the leaf spring and is fastened on the back 14 of the leaf spring in a suitable way, for instance being riveted to the back side of the back 14 of the leaf spring (FIGS. 1, 3 and 4).

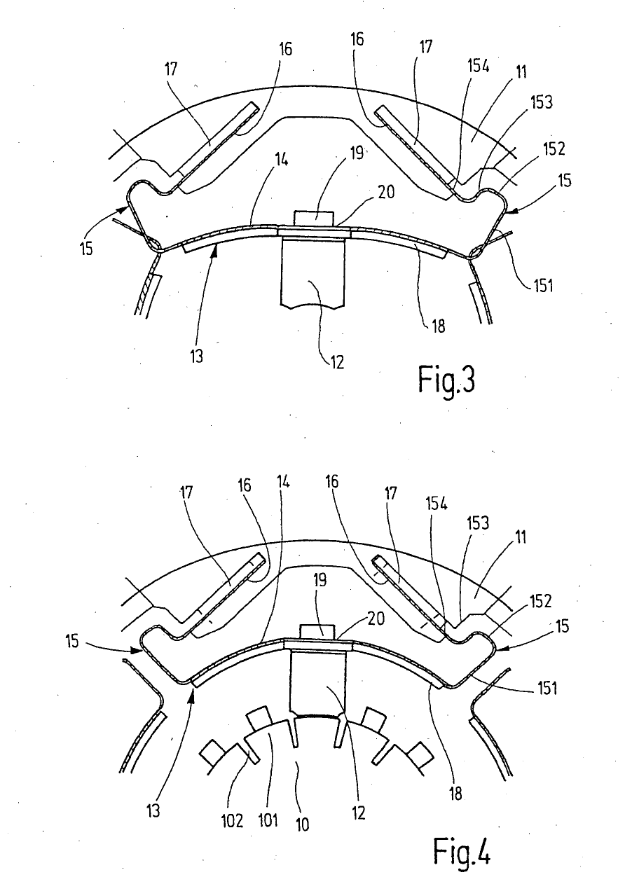

As FIG. 3 shows, when the leaf spring 13 has been fastened in the carrier 11, the back 14 of the leaf spring has a relatively shallow curvature. This curvature is greatly increased by insertion of the commutator 10 into the interior of the brush holder, which causes a radial displacement outward of the sliding bodies 12, and as a result the leaf spring 13 is prestressed and the back 14 of the leaf spring extends substantially concentrically to a portion of the commutator 10, as is shown in FIG. 4.

The sliding body holder, described as an example as a brush holder for a commutator machine, for making an electrical connection with a rotor, in the exemplary embodiment with the commutator 10, can also be used in so-called slipring machines, such as synchronous machines with slipring rotors. In that case, the sliding bodies, known as slip brushes, rest on the sliprings that are seated on the driveshaft of the rotor in a manner fixed against relative rotation and that supply the exciter coil with exciter current. The sliding body holder described here can furthermore be used wherever an electrical touch contact is to be established between one current-carrying component that is spatially fixed and another current-carrying component that rotates relative to it. It is understood that the number of sliding bodies and leaf springs can amount to more or fewer than four.

1-12. (canceled)

13. In a sliding body holder for electrically contacting a rotor, in particular a brush holder for a commutator machine or slipring machine, having at least one sliding body and a leaf spring, which centrally supports the sliding body and on its end is fixed to a carrier that is stationary relative to the rotor, and which spring, at the sliding body, generates a radially oriented contact-pressure force for pressing the sliding body against the rotor, the improvement wherein the geometry of the leaf spring is designed such that the sliding body and the carrier are largely vibrationally decoupled from one another.

14. The sliding body holder as defined by claim 13, wherein the leaf spring comprises an elongated curved leaf back supporting the sliding body and two spring legs which continue one on each end of the leaf back and being embodied resiliently in the longitudinal direction of the back of the leaf spring and in the direction of the normal to the back of the leaf spring.

15. The sliding body holder as defined by claim 14, wherein the back of the leaf spring and the two spring legs are produced in one piece from a common strip of material; and wherein the spring legs are formed from bent portions of the strip of material that are at least partially cut out in the center in order to adjust the resilience.

16. The sliding body holder as defined by claim 15, wherein the strip of material is a copper-alloy spring sheet.

17. The sliding body holder as defined by claim 15, wherein each spring leg comprises a first portion which adjoins the back of the leaf spring and is angled toward the back of the leaf spring such that it rests on the back side, remote from the sliding body, of the back of the leaf spring; a second portion, which is angled away from the first portion in such a way that it points toward the other spring leg and extends preferably approximately parallel to the back of the leaf spring; a third portion, which is angled away from the second portion in such a way that it extends toward the back of the leaf spring, preferably approximately parallel to the first portion; and a fourth portion, which is angled away from the third portion in such a way that it extends away from the first portion, preferably approximately at a right angle to the first portion, and is fastened at its end in the carrier; and wherein a central cutout extends through the first, second and third portions and preferably extends partway into the fourth portion.

18. The sliding body holder as defined by claim 16, wherein each spring leg comprises a first portion which adjoins the back of the leaf spring and is angled toward the back of the leaf spring such that it rests on the back side, remote from the sliding body, of the back of the leaf spring; a second portion, which is angled away from the first portion in such a way that it points toward the other spring leg and extends preferably approximately parallel to the back of the leaf spring; a third portion, which is angled away from the second portion in such a way that it extends toward the back of the leaf spring, preferably approximately parallel to the first portion; and a fourth portion, which is angled away from the third portion in such a way that it extends away from the first portion, preferably approximately at a right angle to the first portion, and is fastened at its end in the carrier; and wherein a central cutout extends through the first, second and third portions and preferably extends partway into the fourth portion.

19. The sliding body holder as defined by claim 17, wherein the fourth portion is clamped in an axial slot present in the carrier.

20. The sliding body holder as defined by claim 18, wherein the fourth portion is clamped in an axial slot present in the carrier.

21. The sliding body holder as defined by claim 17, wherein one contact lug for supplying or drawing current is fastened to the two fourth portions of the spring legs, preferably being riveted, soldered, or welded.

22. The sliding body holder as defined by claim 18, wherein one contact lug for supplying or drawing current is fastened to the two fourth portions of the spring legs, preferably being riveted, soldered, or welded.

23. The sliding body holder as defined by claim 19, wherein one contact lug for supplying or drawing current is fastened to the two fourth portions of the spring legs, preferably being riveted, soldered, or welded.

24. The sliding body holder as defined by claim 20, wherein one contact lug for supplying or drawing current is fastened to the two fourth portions of the spring legs, preferably being riveted, soldered, or welded.

25. The sliding body holder as defined by claim 17, further comprising a contact lug or contact plug for direct plug connection embodied one on each of the two fourth portions of the spring legs by repeated folding and placing on one another of the ends of the strip of material.

26. The sliding body holder as defined by claim 19, further comprising a contact lug or contact plug for direct plug connection embodied one on each of the two fourth portions of the spring legs by repeated folding and placing on one another of the ends of the strip of material.

27. The sliding body holder as defined by claim 13, wherein the back of the leaf spring on its long sides comprises angled portions, protruding toward the sliding body; and wherein the width of the back of the leaf spring is dimensioned such that the sliding body is received between the angled portions, preferably by positive engagement.

28. The sliding body holder as defined by claim 17, wherein the back of the leaf spring on its long sides comprises angled portions, protruding toward the sliding body; and wherein the width of the back of the leaf spring is dimensioned such that the sliding body is received between the angled portions, preferably by positive engagement.

29. The sliding body holder as defined by claim 25, wherein the back of the leaf spring of the leaf spring fastened in the carrier comprises a relatively shallow curvature, which is increased by slipping the sliding bodies onto the rotor, increasing the initial tension of the leaf spring, such that the back of the leaf spring extends approximately concentrically to the rotor.

30. The sliding body holder as defined by claim 19, wherein the carrier is embodied as a ring having pairs of axial slots, offset from one another by equal spacings on the circumference, for clamping the spring legs, by positive engagement, of an even number of leaf springs, preferably two leaf springs, each carrying one sliding body.

31. A commutator machine, in particular an electric motor, having a commutator, which is disposed on a rotor shaft in a manner fixed against relative rotation and concentrically surrounded by an annular carrier and electrically connected to the commutator by means of sliding body holders as defined in claim 13.

32. A commutator machine, in particular an electric motor, having a commutator, which is disposed on a rotor shaft in a manner fixed against relative rotation and concentrically surrounded by an annular carrier and electrically connected to the commutator by means of sliding body holders as defined in claim 14.
